(19) United States
(12) Patent Application Publication
(10) Pub. No.: US 2013/0007041 A1
(43) Pub. Date: Jan. 3, 2013

(54) METHOD AND APPARATUS FOR DETERMINING TARGETED CONTENT TO DELIVER IN A COLLABORATIVE SOCIAL MOBILE PLATFORM

(75) Inventors: Antonio COMPARELLI, Ontario (CA); Jonathan COMPARELLI, Ontario (CA)

(73) Assignee: THE C-FACTOR INCORPORATED, Toronto (CA)

(21) Appl. No.: 13/172,143

(22) Filed: Jun. 29, 2011

(51) Int. Cl. G06F 17/30

(52) U.S. Cl. 707/769; 707/E17.014

(57) ABSTRACT

A system is provided for determining multimedia content to transmit to a device, the system. The system includes a token database storing a plurality of tokens, in which the tokens are tagged one of acquired and unacquired. The system also includes a receiver that receives a scanned token and a comparator module that determines whether the scanned token corresponds to one of the plurality of tokens. A historical database storing predefined token criteria for each of a plurality of token buyers is also included in the system. Also, a marketplace module compares the scanned token to the predefined token criteria in response to the comparator module determining that the scanned token corresponds to one of the plurality of tokens that is tagged unacquired. Also, the system may include a transmitter that transmits multimedia content based on content preselected by one of the plurality of token buyers.

### CROSS-REFERENCE TO RELATED APPLICATION

N/A

### STATEMENT REGARDING FEDERALLY SPONSORED RESEARCH OR DEVELOPMENT

N/A

### FIELD OF THE INVENTION

The present invention relates to mobile device applications and in particular to a method and system for determining multimedia content to transmit to a mobile device.

### BACKGROUND OF THE INVENTION

Social media applications have become commonplace in today's fast pace multimedia environment. These social media applications typically include tools such as interactive tools that allow the user to play games or communicate with other users online. For example, instant messaging or game applications were among the first types of social media applications. The social media application providers would try to generate revenue from these applications through subscription fees but users often did not want to pay such fees. In response, social media application providers began to allow users to interact and use the applications free of charge, relying mainly on advertisements to generate revenue.

However, a disconnect exists between advertisers and application users. In particular, advertisers generally pay the social media provider to play advertisements based on the likelihood the user of the application fits within their target audience. For example, an advertiser may choose to advertise a specific clothing brand to users of an interactive social media application based on the likelihood that the user may be within the age range of 8-14 years old. Yet, the advertiser may end up spending a significant amount of resources advertising to the wrong age group. For example, children toy advertisements may end up being played to 14-17 year olds because teenagers also like to use the same interactive social media application. As such, there exists a need in the art to be able to accurately provide targeted advertising content to social media application users.

Moreover, most social media applications face the same common problems: keeping users interested in the application and generating revenue without charging the user a fee. In particular, today's users tend to jump around from using one social media application to another, often leaving the previous social media application with a small amount of constant users. For example, one media application may initially attract a million users but in less than a year, the amount of constant users of the media application may dwindle down to fewer than 1,000 users. While the social media application providers may continue to offer new features and content to keep users interested and using the application, providers simply do not know whether the new features and content will keep users engaged. As such, there exists a need in the art to keep social media users interacting with a social media application for an extended period of time.

Also, social media application providers often rely on established companies to advertise within the social media application. For example, these established companies may include large clothing manufacturers, advertisement agencies and the like. However, it is usually established social media applications that get the bulk of an established company's advertising revenue because these companies are able to determine the likelihood of the advertisement being displayed to their targeted group based on the constant user's metrics. With new social media applications, advertisers simply do not know whether the media application user is likely to be within their targeted market. Therefore, there exists a need in the art to provide targeted advertising content to application users of less established third party social media applications.

### SUMMARY OF THE INVENTION

The present invention advantageously provides a method and system for determining multimedia content to transmit to a mobile device.

According to one embodiment, a system is provided for determining multimedia content to transmit to a device, the system. The system includes a token database storing a plurality of tokens, in which the tokens are tagged one of acquired and unacquired. The system also includes a receiver that receives a scanned token and a comparator module that determines whether the scanned token corresponds to one of the plurality of tokens. A historical database storing predefined token criteria for each of a plurality of token buyers is also included in the system. Also, a marketplace module compares the scanned token to the predefined token criteria in response to the comparator module determining that the scanned token corresponds to one of the plurality of tokens that is tagged unacquired. Also, the system may include a transmitter that transmits multimedia content based on content preselected by one of the plurality of token buyers.

According to another embodiment, a method is provided for determining multimedia content to transmit to a device. The method includes storing a plurality of tokens in which each of the plurality of tokens is tagged one of acquired and unacquired. Also, the method includes storing a plurality of token buyers in which each token buyer has a corresponding predefined token criteria. The method includes receiving a scanned token, determining the scanned token corresponds to one of the plurality of tokens and determining that at least one of a plurality of token buyers corresponds to the scanned token based on the corresponding predefined token criteria. The method also includes transmitting multimedia content based on one of the plurality of token buyers that corresponds to the scanned token.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a social media system diagram according to one embodiment of the invention;

FIG. 2 illustrates a flowchart of a social media system for determining multimedia content to transmit to a mobile device;

FIG. 3 illustrates a flowchart of a marketplace process for determining a token buyer to acquire a token; and

FIG. 4 illustrates a flowchart of a social media game application incorporating the social media system of FIG. 1 and marketplace process of FIG. 3.

### DETAILED DESCRIPTION OF THE INVENTION

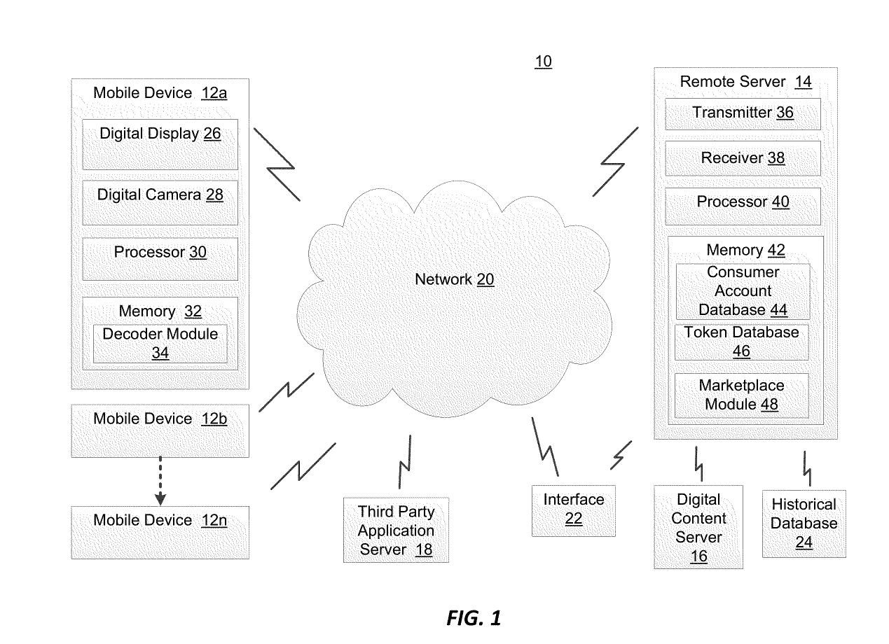

The present invention advantageously provides a system for determining multimedia content to transmit to a mobile device. Referring now to the drawings figures, in which like references designators refer to like elements, there is shown in FIG. 1 a system constructed in accordance with the principles of the present invention and designated generally as “10.” System 10 includes at least one mobile device 12a but can accommodate mobile devices 12a-12n (herein referred to as mobile device 12). The mobile device 12 may be in communication with a remote server 14, digital content server 16, third party server 18, among other networking elements via network 20.

In particular, remote server 14 may contain several software and hardware modules. The software modules may be computer programs stored on volatile or non-volatile computer memory that when executed by a computer processor, cause the processor to perform certain steps. In particular the software modules may each perform specific tasks as will be described in detail below. Remote server 14 may be communicatively coupled to interface 22 such as a kiosk, tablet, mobile device 12 and the like, that may allow for direct access to remote server 14. Digital content server 16 may also be included in system 10 for storing and delivering messages. The digital content may include audio, video, graphical, among other types of content. Historical database 24 may be communicatively coupled to remote server 14 via telecommunication methods known in the art. Historical database 24 may store token buyer information.

Mobile device 12 may include devices such as a cellular phone, laptop device, tablet device, personal digital assistant (PDA), and the like. Specifically, mobile device 12 may have various hardware components and software modules. For example, mobile device 12 may include digital display 26 such as an liquid crystal display (LCD), light-emitting diode (LED) display, thin film transmitter (TFT), thin film diode (TFD), active-matrix organic light-emitting diode (AMOLED), touch screen, among other display types. Mobile device 12 may also have digital camera 28 such as a camera phone or webcam. Digital camera 28 may be an add-on element that connects to mobile device 12 via a universal serial bus interface (USB), serial port, parallel port, among other types of computer communication connections.

Mobile device 12 also includes processor 30 such as a central processor unit (CPU), as is known in the art, for processing and carrying out computer program instructions. Memory 32 may include violate and non-volatile memory as is known in the art. Memory 32 may include decoder module 34 that operates to decode an image captured by digital camera 28, e.g., decode an image of a Quick Response (QR) code captured by digital camera 28. In particular, decoder module 34 may be a software application, stored in memory 32, running on mobile device 12 that instructs mobile device 12 to take a picture using digital camera 28 and decodes the captured image using decoding methods known in the art.

Furthermore, mobile device 12 may include a Radio Frequency Identification (RFID) scanner (not shown) to scan an RFID token. For example, the RFID scanner may transmit interrogation signals that cause the RFID token to transmit data. The received data may be decoded by mobile device 12 using decoding methods known in the art. Other types of readers or scanners may be used in accordance with the invention. Also, other software modules or mobile device applications may also be used individually or in combination with decoder module 34 to carry out image capturing, decoding, data inputting (i.e., touch screen keyboard), transmitting, receiving, among other functions performed by a mobile device.

Moreover, mobile device 12 communicates through network 20 using communications methods known in the art so as to communicatively couple mobile device 12 to network 20 that may include a wide area network (WAN), local area network (LAN), wired and wireless networks, cellular network, metropolitan area network (MAN), among others communication networks. For example, mobile device 12 may include a transceiver, transmitter, receiver and the like. Also, mobile device 12 may include a corresponding network interface (not shown) that allows mobile device 12 to transmit and receive data via network 20. The network interfaces may include telephone interfaces, satellite interface, wide area network interface, local area network interface, wireless communication interfaces, among other interfaces.

Still referring to FIG. 1, system 10 may include remote server 14 in communication with network 20 via communication methods known in the art such as those describe with respect to mobile device 12. Remote server 14 may include transmitter 36, receiver 38, processor 40, memory 42, consumer account database 44, token database 46, and marketplace module 48, among other modules and hardware. Transmitter 36 may transmit data packets to networking elements communicatively coupled to network 20. Receiver 38 may receive data packets from networking elements communicatively coupled from network 20. Processor 40 may include a central processor unit (CPU) that functions in substantially the same manner as processor 30.

Memory 42 may be volatile and non-volatile memory as are known in the art and may also include external memory. Memory 42 may include consumer account database 44 that contains various types of account information such as consumer account data, distributor account data, among other data. For example, the consumer account data may include name, age, gender, city, zip code, area code, state, address, mobile identification number, mobile number, credit/debit card information, password, financial institution information, distributor identification number, among other data. The consumer account data may be obtained when a mobile device user, distributor or consumer subscribes/registers to a social media application via online website. Also, consumer account database 44 may be stored in external memory (not shown).

Also, Memory 42 includes token database 46 that stores tokens and corresponding token information. A token may include a QR code, any other visual tokens, RFID tokens, among other tokens. The QR code may consist of black modules arranged in a pattern on a white background. Specifically, the QR code may include entity data, advertisement data, location data, distributor data, among other data. Other types of codes may also be used such as micro QR code, linear barcodes, other two dimensional barcodes and other codes that are an optical machine readable representation of data. The codes may include less, more or the same amount of information as the QR code. Also, RFID tokens may include passive, active or semi-active RFID tokens, among other types known in the art. The token information may include token status, token coding information, a tag indicating whether the token is acquired or unacquired, corresponding consumer account number, token history, content indicator, corresponding advertiser, among other information. Token database 46 may also be stored in external memory (not shown).

Historical database 24 may store token buyer or token requester information and be communicatively coupled to remote server 14 and/or network 20. For example, the token buyer information may include organization/business entity name, address, city, zip code, area code, buyer identification number, financial institution information, corresponding predefined token criteria(s), among other information. In particular, the financial institution information may include payment information such as credit/debit card, bank information, among other payment information.

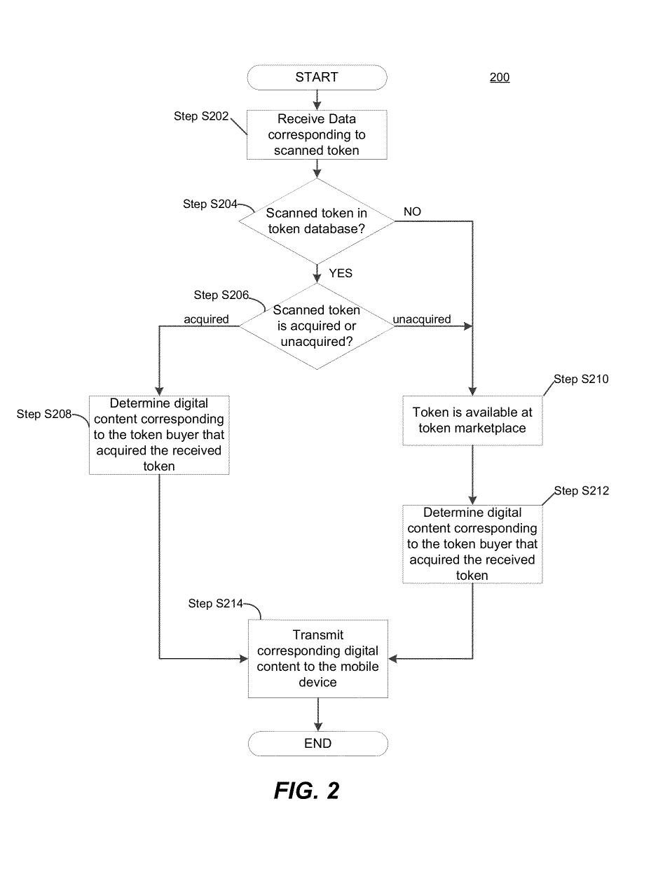

Still referring to FIG. 1, memory 42 may include marketplace module 48 that determines which token buyer is going to acquire the unacquired token. For example, the market place module 48 determines which token buyer's request is going to be granted so that the token buyer acquires a token that is tagged as unacquired, i.e., not acquired. In particular, marketplace module 48 may compare the scanned token information and/or the consumer account information with the token buyer information stored in historical database 24 to determine which buyer will acquire an unacquired token. Marketplace module 48 may also be stored in external memory (not shown). The marketplace process that determines the acquiring token buyer is discussed below with reference to FIG. 2.

The predefined token criteria(s) are token buyer request(s) defined by various factors corresponding to each token buyer's needs, i.e., token selection criteria. Specifically, the predefined token criteria is a set of factors that define the scope of the of the buyer's request. For example, the set of factors may include age, gender, city, zip code, area code, state/providence, category, day of week, time of day, date, consumer activity, mobile device type, highest bid, account balance, token data, among other factors. The token buyer may customize each factor to its specific needs, e.g., customize the age factor to include users of ages 16-21. The category factor may indicate the token is associated with packaged goods, entertainment, services, real-estate and the like. The consumer activity factor may indicate a required mobile device user activity level. For example, the activity level may correspond to a particular category factor, to the user's activity in the social media game, among other measurable user activity.

Moreover, the mobile device type factor may indicate the kinds of digital content mobile device 12 may process, display and/or play for the user. For example, a mobile phone may not be able to process certain types or sizes of digital content while a tablet device may be able to process such content. The highest bid factor may indicate the maximum price the buyer will pay to purchase the token. The account balance factor may indicate the amount of tokens the buyer may purchase without replenishing the account with more assets. The token data factor may include the token buyer's token preferences. For example, the token data factor may indicate the token buyer preferences relate to the buyer's brand or product.

System 10 may also include digital content server 16 communicatively coupled to remote server 14 and/or network 20. Digital content server 16 may store digital content such as video, audio, graphical, among other types of content that may be transmitted to a mobile device. For example, the digital content may include video movie previews, graphical advertisements, discount offers, games, among other types of digital content that may be processed by the mobile device. Furthermore, the various types of digital content stored in digital content server 16 correspond to at least one of the tokens stored in token database 46, the buyer's account stored in historical database 24, a default buyer account, among others. For example, the digital content may be tagged with the buyer's account number. Also, interface 22 may be communicatively coupled to remote server 14 and/or network 20. Interface 22 may allow buyers, consumer, service operators, and the like to update and configure remote server 14, historical database 24 and digital content. For example, interface 22 may include a website, kiosk, touch screen interface, among other interfaces, that may allow the token buyer to update the buyer's advertisements.

Referring to FIG. 2, there is illustrated process 200 for determining targeted content to transmit to at least mobile device 12 based on the scanned or captured token received at remote server 14, e.g. remote server 14 performs the process in response to receiving a scanned token. Process 200 includes receiving data corresponding to a scanned token. (Step S202). For example, mobile device 12 may use digital camera 28 to capture the visual token and may transmit token data along with its mobile identification number to the remote sever via network 20. Token data may include the scanned token and corresponding token information. Remote server 14 accesses token database 46 to determine whether the scanned token is stored in token database 46. (Step S204). For example, remote server 14 may compare the stored token data in token database 46 with the scanned token data. If the scanned token data does not match one of the stored tokens in the token database 46, i.e., the scanned token is new, the token database 46 may be updated to store the scanned token, in which the scanned token may be tagged as unacquired, thereby becoming available at the token market, discussed below. (Step S210).

However, if remote server 14 determines the scanned token is stored in the token database 46, remote server 14 accesses historical database 24 and/or token database 46 to determine whether the scanned token has already been acquired by a token buyer or remains unacquired, i.e., a comparator module is used to compare scanned token information with data in the historical database 24 and/or token database 46. (Step S206). The comparator module may be computer program instructions stored in memory 42 that when executed by processor 40 causes processor 40 to perform certain steps. Also, each token in token database 46 may be tagged as acquired or unacquired. For example, a clothing manufacturer may have acquired all the tokens in token database 46 relating to the clothing manufacturer, in which token database 46 tags the purchased tokens as acquired by the token buyer. As such, remote server 14, in this example, may determine the clothing manufacturer has acquired the scanned token. (Step S206).

Also, remote server 14 accesses digital content server 16 to determine the digital content the buyer has indicated as corresponding to the scanned token, e.g., digital content may be tagged with the buyer's account number. (Step S208). Continuing the example, the clothing manufacturer (buyer) may have indicated the scanned token corresponds to specific digital content such as a video advertisement for a clothing item from the clothing manufacturer. Alternatively, the clothing manufacturer could indicate that all its acquired tokens correspond to a particular graphical advertisement.

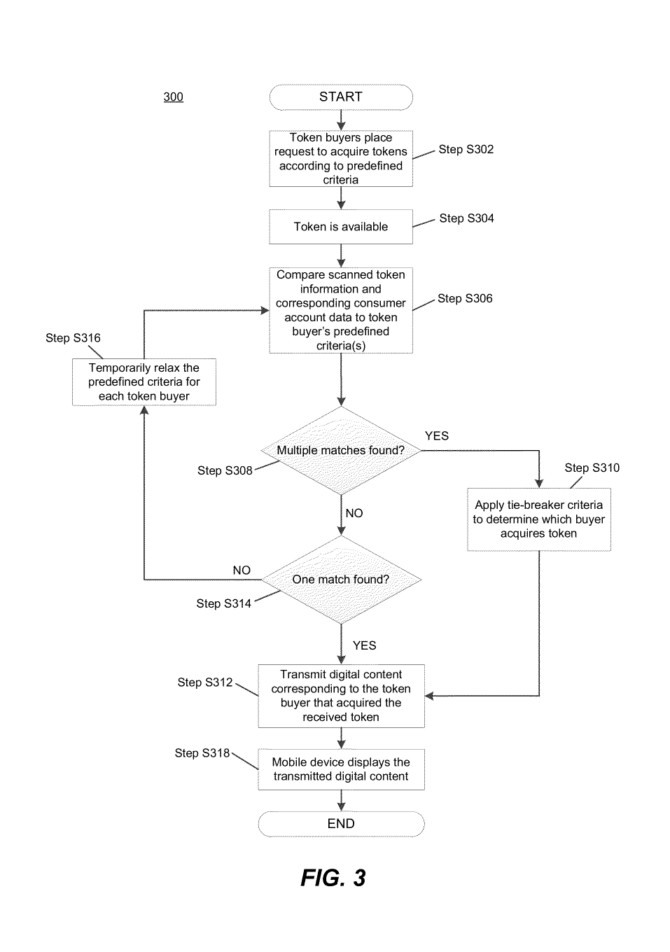

However, if historical database 24 does not find that the scanned token corresponds to a token buyer in token database 46, remote server 14 determines that the scanned token is unacquired, e.g., token stored in token database 46 but not purchased or not acquired. (Step S206). Remote server 14 may use the marketplace module 48 to acquire a buyer for the unacquired token, e.g., the token becomes available at the token marketplace. (Step S210). The process by which marketplace module 48 determines a buyer for an unacquired token is described in detail below with reference to FIG. 3. When the unacquired token gets acquired by the buyer at the token marketplace, the remote sever 14 may access digital content server 16 to determine the digital content that the buyer indicates corresponds to the newly acquired token, e.g., digital content may be tagged with the buyer's account. (Step S212). For example, the remote server 14 may determine the buyer's digital content corresponds to a specific video advertisement. The determined digital content is transmitted to at least the mobile device 12 that transmitted the scanned token. (Step S214). The determined digital content may also be transmitted to other devices corresponding to the mobile device user such as a personal computer, among other devices associated with the user.

Also, a previously acquired token may be retagged as unacquired if the buyer no longer wants the token or if the buyer's account balance is insufficient to pay for scanned tokens. For example, the token buyer may keep the acquired token after the digital content is transmitted to mobile device 12 (Step S214), as long as the buyer has sufficient funds to pay when another mobile device user scans the same token. Alternatively, some tokens may by automatically retagged as unacquired after the digital content is transmitted, Step S214, so that the token is always available at the marketplace after the digital content has been transmitted to the mobile device.

Remote server 14 may a load adjust feature (not shown) to ensure the token buyers acquire tokens only for unique delivery of their content within a predetermined time period, e.g., same player/mobile device re-scans the same token within a predetermined time period may not be a unique delivery to the token buyer. In particular, remote server 14 may build a token profile containing information about mobile device 12 that scanned the token, the scanned token, whether the token is acquired or unacquired, which buyers have previously acquired the token, among other information. For example, when a scanned token is received, remote server 14 determines whether the token profile has been previously generated for the scanned token. If no token profile exists, remote server 14 generates a token profile corresponding to the scanned token and proceeds to Step S210, e.g., token is new.

However, if a token profile already exist, remote server 14 compares the token profile to the token buyer who acquired the scanned token at steps S208 or step S212. In particular, remoter server 14 determines whether the token buyer at step S208 or step S212 has previously acquired the scanned token from the same mobile device 12. If the token buyer has not previously acquired the scanned token from the mobile device, corresponding digital content is transmitted to mobile device 12. (Step S214). If the token buyer has previously acquired the scanned token from the same mobile device 12, remote server 14 determines whether the corresponding digital content to be transmitted is substantially the same as the previously transmitted digital content of the token buyer. If the digital content is not substantially the same, corresponding digital content is transmitted to mobile device 12. (Step S214). If the digital content is substantially the same, remote server 14 determines whether the scanned token is received within the acquiring token buyer's predetermined time period. The predetermined time period may be a default time period for each token buyer or may be dynamically set by each token buyer, e.g. the token buyer may define the predetermined time period to be thirty days. If the scanned token is not received within a predetermined time period, the corresponding digital content is transmitted to mobile device 12. (Step S214). However, if the scanned token is received within a predetermined time period, remote server 14 may mark the scanned token as unacquired and make the scanned token available at the token marketplace (Step S210) while temporarily preventing the currently matched token buyer from acquiring the scanned token, i.e., token buyer does not want to acquire the same token and send substantially the same digital content to the same mobile device within a predetermined time period. Moreover, there may also be a token buyer threshold in which the token buyer may acquire the same token from the same mobile device 12, within the predetermined time period, a predefined number of times, e.g., five times. The token buyer threshold may be a default number and/or may be dynamically set by the token buyer. As such, load adjust enables token buyers to further customize which tokens they may acquire during a given period of time.

Referring to FIG. 3, the process 300 by which marketplace module 48 determines the buyer that acquires the unacquired token is illustrated. A buyer such as a business entity may place a request via interface 22 to purchase or acquire specific tokens according to predefined criteria(s). (Step S302). For example, the buyer may request to purchase tokens corresponding to a certain set of token factors such as time of day, age/gender of mobile device user, among other factors as previously discussed. These factors are used to determine whether the buyer's predefined criteria and scanned token data match, as discussed below. Alternatively, remote server 14 may determine the token is available. (Step S304). For example, the token may be determined to be available for purchase based, in part, on remote server 14 determining no match exists between predefined criteria and token data. Also, availability of the token may be determined by the token being tagged as unacquired, i.e. not acquired, in token database 46.

If the token is available, remote server 14 may access historical database 24 to determine whether the unacquired scanned token and consumer account data match a buyer's predefined token criteria. Specifically, the match between the buyer's predefined token criteria and the unacquired token may be determined based on matching several or all of the buyer's token criteria with the scanned token data and corresponding consumer account data. (Step S306). For example, a match may be found corresponding to age/gender of the mobile device user, time of day and area code but not as to token category. Accordingly, remote server 14 may determine that the scanned token does not match the buyer's predefined token criteria due to the missing factors. Alternatively, remote server 14 may determine that the token does match the buyer's predefined criteria because the buyer gave priority to one factor over others, thereby overcoming the other missing factors. The matching is repeated for some or all buyers to determine whether other buyers match.

Still referring to FIG. 3, remote server 14 determines whether multiple matches were found. (Step S308). If multiple matches, i.e., multiple buyers, were found to match, remote server 14 determines which buyer will acquire the token based on a tie-breaker criteria. (Step S310). The tie-breaker criteria may include factors such as highest price offered, preferred buyer, buyer location, among other factors. For example, remote server 14 may determine buyer A bid more than Buyer B; therefore, Buyer A will acquire the tag based on the highest offered price factor. The tie-breaker criteria may include all or some of the factors listed above, and may assign weights to certain factors, i.e., the highest price factor may count for double the weight of the buyer location factor. Specifically, remote server 14 may weigh the factors such that a missing factor may get a 0.0 weight while a factor found to be met gets between a 0.1 to 1.0 weight. A match may be determined by reaching a combined factor weight of 0.8; however, the exact match threshold value may vary above or below 0.8. For example, the age/gender factor may get a weight of 0.9 while the area code factor may get a weight of 0.2, therefore, a match may be found based on the 0.8 match threshold value if only the age/gender factor is met.

After the tie-breaker criteria is applied and the acquiring buyer is determined, remote server 14 may search the digital content server 16 to determine the digital content corresponding to the acquiring buyer and may transmit the content to mobile device 12 that transmitted the scanned token, i.e., transmits digital content corresponding to the token buyer that acquired to the received token. (Step S312). If no multiple buyers were found, remote server 14 may determine whether one match is found. (Step S314). If no buyer match was found, remote server 14 may temporarily relax the predefined token criteria for each buyer in order to determine the acquiring token buyer. (Step S316). For example, one or more factors from a buyer's predefined token criteria may be removed, the factors may be re-weighed so as to give priority to a different factor, or the match threshold may be lowered. Specifically, one or more of the factors may be removed from the buyers' token criteria so as to widen the scope of each buyer's token request. Continuing the example, the age/gender factor may be re-weighed so as to have the greatest weigh value when determining if the token matches the buyer's predefined token criteria, thereby increasing the possibility of finding a match if the token falls within the age/gender factor of the buyer's predefined token criteria. Also, the match threshold may be lowered so as to increase the possibility of at least one buyer matching. After the predefined token criteria for each buyer has been temporarily relaxed, remote server 14 again searches for buyer matches. (Step S306). Remote server 14 may continue to relax the token criteria for each buyer until at least one buyer match is found. (not shown).

Moreover, remote server 14 may determine that only one match is found. (Step S314). The matching or acquiring buyer is charged for the token, i.e., buyer purchases the token. For example, remote server 14 may charge the matching or acquiring buyer for the acquired token based on credit/debit card information, banking information, among other transactional information. The specific amount charged for the token varies based on the scope of the buyer's predefined token criteria. For example, the more factors included in the buyer's token criteria, the higher the cost of acquiring the token that matches these factors. In other words, the more targeted the buyer's predefined token criteria becomes the higher the charge. Also, buyers may establish different types of budgets for purchasing tokens based on their needs. For example, a buyer may establish an “open to buy” budget that enables the buyer to purchase a maximum amount of tokens in token database 46.

After the charge has been authorized, remote server 14 may search digital content server 16 to determine the digital content to transmit to mobile device 12 that transmitted the scanned token. (Step S312). For example, the matching buyer may pre-select digital content to be transmitted when a particular scanned token is received. Alternatively, the matching buyer may pre-select default digital content to be transmitted when any of the buyer's acquired tokens are received.

The digital content may be sent to mobile device 12 directly from digital content server 16, remote server 14 and/or from other content servers via network 20. The transmitted digital content is displayed at the mobile device. (Step S318). Accordingly, the displayed digital content at mobile device 12 is customized based on a buyer's targeted market in accordance with the buyer's predefined token criteria. After the digital content has been transmitted, the predefined criteria may be restored back to the default or predetermined settings, i.e., undo the relaxed predefined criteria.

Marketplace module 48 may also be accessed by third party servers 18 hosting third party applications. In particular, mobile devices running third party software may scan tokens and transmit the scanned token information to third party server 18. Third party server 18 may then transmit the scanned token information to the remote server 14 for processing similar to the mobile device user transmitting the scanned token information directly to remote server 14. The predefined token criteria may be continuously updated by the buyer at interface 22 or through communication with remote server 14 via network 20. For example, the token buyer may update its corresponding predefined criteria in order to target different age groups or to target a specific location (zip code, city, etc.).

Also, the digital content may be transmitted to third party server 18 or directly to a third party mobile device 12 via network 20. In other words, the third party server 18 may function as a distributor of digital content to its third party users. The remote server 14 may manage one or more of the third party server accounts, e.g. distributors, under one or more consumer accounts stored in consumer account database 44. As such, remote server 14 may treat third party servers similar to the mobile device users.

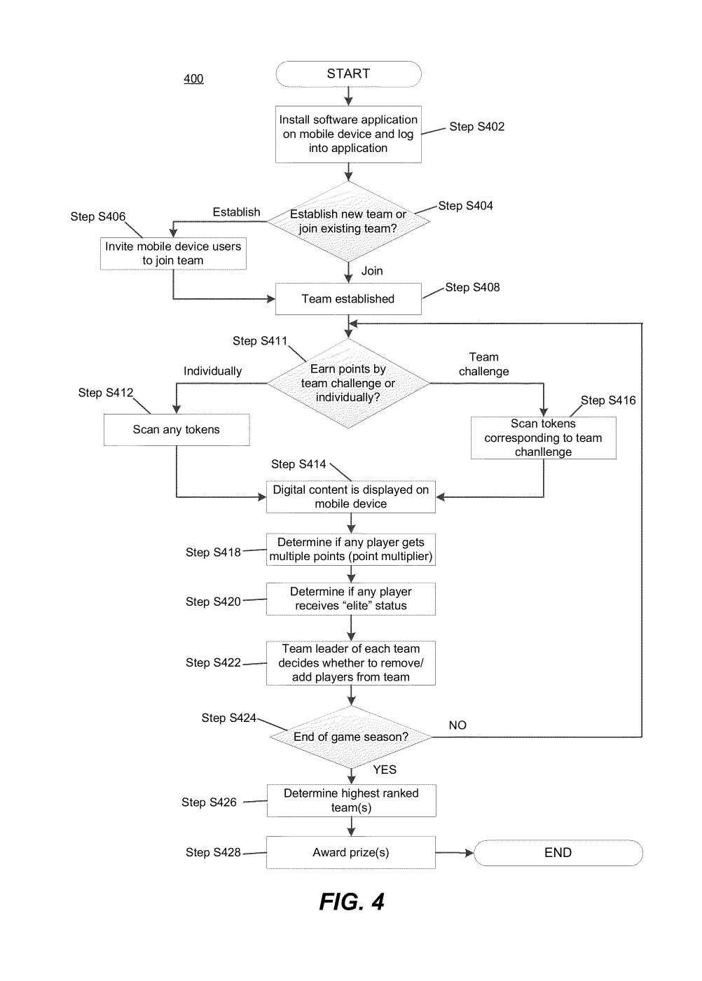

Referring to FIG. 4, an example of a social media application incorporating the processes of FIG. 2 and FIG. 3 is illustrated via flowchart 400. Mobile device users install the social media application on their respective mobile devices and log onto the social media application. (Step S402). The media application may be downloaded to mobile device 12 from remote server 14, third party server 18, among other media application providers, via network 20. Once the user logs into the media application, the mobile device user may choose to establish a new team, join an existing team, or continue the game (not shown), among other options. (Step S404). If the mobile device user chooses to establish a new team, the user may invite other media application players to join the new team. (Step S406). Also, the user who established the new team may be designated the team's sole team leader, as discussed below. Alternatively, the user may choose to join an existing team. (Step S404). For example, the user may be invited to join an existing team, may select from a list of teams, and the like. As such, one or more new teams may be established and participate in the social media application according to FIG. 4.

In particular, each team consists of a team leader and several team members that play individually and in collaboration with each other to earn the greatest amount of points for themselves and the team within a game season. The team leader may be the user that created a particular team or may be elected team leader by the team members. The game season may be any time period such as a month, week and the like, in which there may be several game seasons in a given calendar year.

As the game season begins, each player on a given team earns points by scanning random tokens with their respective mobile device, through team challenges, among other ways. (Step S410). Specifically, a player using mobile device 12 may scan any tokens. (Step S412). For example, QR codes may be located on billboards or magazines that may be scanned by the players. The data corresponding to the scanned QR code is transmitted via network 20 to remote server 14 for processing. (e.g., FIG. 2, Step S202). Remote server 14 processes the QR code in accordance with the process of FIG. 2. The player may be awarded points for the scanned token and the player's profile may be updated in consumer account database 44, i.e., each player's/user's points are tracked. In response to transmitting the scanned QR code to remote server 14, mobile device 12 receives and plays digital content on the mobile device display in response to the transmitted QR code. (e.g., FIG. 2) (Step S414). Also, points may be awarded only after the player confirms the digital content was viewed, e.g., the player may be prompted to enter an input on mobile device 12 after the digital content is displayed.

Team challenges are another way the players earn points. (Step S416). In particular, these challenges may require players to scan or capture specific tokens found at specific venues, eateries, and the like. For example, players may be required to capture the token on display within a particular clothing store, thereby encouraging players to look around the store for the token. Also, the token may be displayed only after the player purchases a product from a local store. For example, the token may be printed on a receipt, emailed to the player, temporarily displayed on a display, among other ways to display the token for capture. (Step S414).

The points earned by each player in the team challenges may vary depending on the level of participation of the team. For example, a team challenge may request the players watch a certain movie at a theater, in which the QR code may print on the movie ticket stub or may be displayed at the end of the movie. If a certain percentage of a team's players scan the QR code, each player's earned points for scanning the QR code may be multiplied, e.g. multiplied by two. (Step S418). If all a team's players scan the QR code, each player's earned points for scanning the QR code may be multiplied by a greater number, e.g. multiplied by four. Accordingly, the higher the percentage of a team's players that participate in a team challenge, the greater the points multiplier and the greater the increase in number of earned points. The certain percentage required to receive multiple earned points may vary. (Step S418).

In another example, the team challenge may include watching a baseball game between two specific baseball teams on a certain date. Each participating player may be required to buy a ticket and attend the baseball game, in which a QR code may be periodically displayed on the stadium jumboTron or large stadium television. As discussed above, the higher the percentage of a team's players that participate in the team challenge at the baseball game, the greater the multiplier and the greater the increase in number of earned points. (Step S418).

Also, depending on each player's activity level in the social media game, the player may receive different bonuses. For example, each player may have an experience meter that increases each time the player earns points or scans the token. The experience meter may have particular levels or ranges where the player at a certain level or within a range will receive bonus points. For example, the player's bonus points may be a multiplier such that the points being received for a scanned token are multiplied by a number such as two (double the points). Other numbers may be used depending on experience level or range. (Step S418).

In another example of a bonus, the player may earn Elite status by scanning and participating in more than an elite threshold amount of QR codes and team challenges, respectively. (Step S420). For example, to reach Elite status the player may be required to scan at least forty QR codes and participate in at least three team challenges within a given game season. The elite threshold amount may vary as to required scans and team challenge participation, and may also include total number of points, among other factors. Players with elite status may be grouped together and have an additional chance to be rewarded individually at the end of the season based on total points earned in a season. Also, elite status players may earn individual point multipliers for each scanned QR code.

Earned points are tracked for each player and team, in which the earned points for each player in a team are added together to generate an earned team points total. The earned team points total for each team is used to rank the teams from highest point total (first place) to the lowest point total (last place). The ranks may be updated continuously in real time or periodically. Moreover, the team leader may have the capability to remove and add players from the team at any time (Step S422), but the earned team points total will decrease by the removed player's earned points. For example, if player A is removed from Team AA, the earned team points total for Team AA will be decreased by player A's earned points. Also, if Player A joins Team BB, the earned team points total for Team BB will be increased by player A's earned points. In other words, the player's earned points remain with the player that was kicked off a team. However, if the player quits the team, the quitting player's earned points remain with the previous team and the player's earned points resets to zero, i.e., the player's earned points will not transfer to a new team. Players on any team my quit and rejoin another or the same team at anytime during the season.

Players continue to earn points until the end of the game season. (Step S424). At the end of the game season, the team rank is updated and the top team or teams may be awarded a prize or prizes. (Step S426-S428). For example, the three highest rank teams may each receive a share of a prize. The prize may include cash, credits, gifts, coupons, among other assets. In other words, the winning or top teams each receive a share of the prize. The share of the prize received by each winning teams may be the same or may vary depending on several factors, e.g., earned team point total. Moreover, each team's share of the prize may be divided equally or unequally among the team's players.

For example, the top three teams are determined based on the updated team rank at the end of the game season. These three teams may be Team D, Team E and Team F with Team D and Team E each containing 5 players each, and Team F containing 10 players. These teams may equally split a jackpot of 90,000 credits, i.e., each team will receive 30,000 credits. Each team may then equally split its respective share of the credits such that players on Team D and Team E each receive 6,000 credits. However, each player on Team F will only receive 3,000 credits. Accordingly, the team leaders must consider many factors in determining how many team members should be on a team.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implement of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A system for determining multimedia content to transmit to a device, the system comprising:
a token database storing a plurality of tokens, the tokens being tagged one of acquired and unacquired;
a receiver receiving a scanned token;
a comparator module determining whether the scanned token corresponds to one of the plurality of tokens;
a historical database storing predefined token criteria for each of a plurality of token buyers;
a marketplace module comparing the scanned token to the predefined token criteria in response to the comparator module determining the scanned token corresponds to one of the plurality of tokens that is tagged unacquired; and
a transmitter transmitting multimedia content based on content preselected by one of the plurality of token buyers.

2. The system of claim 1, wherein the marketplace module determines at least one of the plurality of token buyers corresponds to the scanned token based on corresponding predefined token criteria.

3. The system of claim 2, wherein the marketplace module applies a tie-breaker criteria in response to determining more than one of the plurality of token buyers corresponds to the scanned token, the tie-breaker criteria including selecting one of the plurality of token buyers based on a highest bidding price.

4. The system of claim 3, wherein the transmitted multimedia content corresponds to content preselected by the selected one of the plurality of token buyers.

5. The system of claim 1, wherein the marketplace module modifies the predefined token criteria in response to determining none of the plurality of token buyers corresponds to the scanned token.

6. The system of claim 1, wherein the predefined token criteria includes at least one of age, gender, geographical location, category, weekday and time of day.

7. The system of claim 1, wherein the scanned token is a scanned Quick Response (QR) code.

8. The system of claim 7, wherein the scanned token information is received from a mobile device.

9. The system of claim 1, wherein the scanned token information is received from a third party distributor.

10. The system of claim 1, wherein the scanned token is a scanned Radio Frequency Identification (RFID) tag.

11. A method for determining multimedia content to transmit to a device, the method comprising:
storing a plurality of tokens, each of the plurality of tokens being tagged one of acquired and unacquired;
storing a plurality of token buyers, each token buyer having a corresponding predefined token criteria;
receiving a scanned token;
determining the scanned token corresponds to one of the plurality of tokens;
determining that at least one of the plurality of token buyers corresponds to the scanned token based on the corresponding predefined token criteria; and
transmitting multimedia content based on one of the plurality of token buyers that corresponds to the scanned token.

12. The method of claim 11, further comprising comparing the received scanned token to the predefined token criteria for each of the plurality of token buyers in response to determining the one of the plurality of tokens is tagged as unacquired.

13. The method of claim 11, further comprising:
determining more than one of the plurality of token buyers corresponds to the scanned token based on corresponding predefined token criteria; and
selecting one of the plurality of token buyers based on a highest offer price.

14. The method of claim 13, wherein the transmitted multimedia content is content preselected by the selected one of the plurality of token buyers.

15. The method of claim 11, further comprising temporarily modifying the predefined token criteria for each token buyer in response to determining that none of the plurality of token buyers corresponds to the scanned token.

16. The method of claim 11, wherein the scanned token is received from a mobile device.

17. The method of claim 11, wherein the scanned token is received from a third party distributor.

18. The method of claim 11, wherein the predefined token criteria includes at least one of age, gender, geographical location, category, weekday and time of day.

19. The method of claim 11, wherein the scanned token is a scanned Radio Frequency Identification (RFID) tag.

20. The method of claim 11, wherein the scanned token is a scanned Quick Response (QR) code.
